(19) United States
(12) Patent Application Publication
(10) Pub. No.: US 2016/0299686 A1
(43) Pub. Date: Oct. 13, 2016

(54) DISK DEVICE AND CONTROLLING METHOD OF DISK DEVICE

(71) Applicant: Kabushiki Kaisha Toshiba, Tokyo (JP)

(72) Inventors: Yasuyuki Nagashima, Yokohama Kanagawa (JP); Michihiko Umeda, Yokohama Kanagawa (JP); Seiji Toda, Kawasaki Kanagawa (JP); Minoru Yamamoto, Kawasaki Kanagawa (JP)

(21) Appl. No.: 14/803,490

(22) Filed: Jul. 20, 2015

Related U.S. Application Data
(60) Provisional application No. 62/144,605, filed on Apr. 8, 2015.

(51) Int. Cl. G06F 3/06; G06F 12/06

(52) U.S. Cl. CPC G06F 3/061; G06F 3/0659; G06F 3/0674; G06F 12/0646; G06F 2212/1016; G06F 2212/224

(57) ABSTRACT

According to one embodiment, there is provided a disk device including a disk to store data and a controller to control writing data to the disk and reading data from the disk. The controller queues a command from a host device, executes a first command included in the queued command, and executes reordering processing to a plurality of commands which accesses a vicinity of a physical position of an access destination of the first command.

### CROSS-REFERENCE TO RELATED APPLICATIONS

This application is based upon and claims the benefit of priority from U.S. Provisional Application No. 62/144,605, filed on Apr. 8, 2015; the entire contents of which are incorporated herein by reference.

### FIELD

Embodiments described herein relate generally to a disk device and a controlling method of the disk device.

### BACKGROUND

In a disk device, a command issued from a higher level device (host device) is queued. Furthermore, in order to shorten time to access a medium, reordering which changes the execution order of commands is performed to all of the queued commands. However, recently, the number of commands which can be queued in the disk device has been increased, and time to perform reordering processing is increasing.

### BRIEF DESCRIPTION OF THE DRAWINGS

FIG. 1 is a block diagram schematically illustrating an example of an outline configuration of a disk device according to a first embodiment;

FIGS. 2A and 2B are diagrams to explain group classification information;

FIG. 3 is a flowchart illustrating an example of a procedure of group classification processing of a command;

FIG. 4 is a diagram schematically illustrating an example of commands stored in a command queue;

FIGS. 5A and 5B are flowcharts illustrating an example of a procedure of reordering processing of commands;

FIG. 6 is a flowchart illustrating an example of a procedure of first another table reference processing;

FIG. 7 is a flowchart illustrating an example of a procedure of second another table reference processing;

FIGS. 8A and 8B are diagrams schematically illustrating an example of a command state in the command queue;

FIGS. 9A to FIG. 9C are diagrams illustrating an example of a command state in the command queue;

FIG. 10 is a diagram illustrating an example of command classification information;

FIG. 11 is a diagram schematically illustrating an example of a method for determining a table reference direction according to a second embodiment; and

FIG. 12 is a flowchart illustrating an example of a procedure of the table reference direction determination processing according to the second embodiment.

### DETAILED DESCRIPTION

According to one embodiments, there is provided a disk device including a disk configured to store data and a controller configured to control writing data to the disk and reading data from the disk. The controller is configured to queue a command from a host device, execute a first command included in the queued command, and execute reordering processing to a plurality of commands which accesses a vicinity of a physical position of an access destination of the first command.

The embodiments of a disk device and a controlling method of the disk device will be explained below in detail with reference to the accompanying drawings. The present invention is not limited to the following embodiments.

### First Embodiment

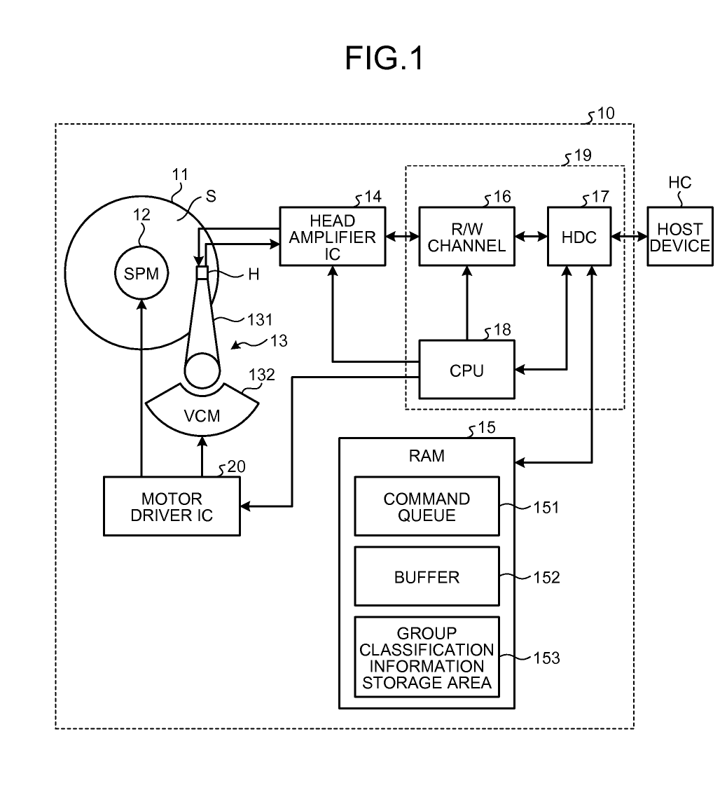

FIG. 1 is a block diagram schematically illustrating an example of an outline configuration of a disk device according to a first embodiment. A hard disk drive (HDD) and the like can be exemplified as the disk device.

A disk device 10 includes a disk 11, a spindle motor 12, a head stack assembly (hereinafter, referred to as an HSA) 13, a head amplifier integrated circuit (hereinafter referred to as a head amplifier IC) 14, a random access memory (hereinafter referred to as a RAM) 15, a read/write channel (hereinafter referred to as an R/W channel) 16, a hard disk controller (hereinafter referred to as an HDC) 17, a central processing unit (hereinafter referred to as a CPU) 18 which is an example of a processor, and a motor driver IC 20.

The disk 11 has a recording surface S, on which data is recorded, and is rotatively driven by the spindle motor 12. A plurality of disks 11 is provided in the disk device 10. Furthermore, a physical address which is position information indicating a physical position on the recording surface S is set to all of the recording surfaces S included in the disk device 10. The physical address is assigned, for example, in units of a sector. The spindle motor 12 is driven by current (or voltage) supplied from the motor driver IC 20.

The HSA 13 has a head H, a head suspension 131, and a voice coil motor (hereinafter referred to as a VCM) 132. The head H is provided for each of the recording surfaces S of the disk 11. The head H has a write head used to write data onto the disk 11 and a read head used to read data from the disk 11.

The head suspension 131 supports the head H and is provided for each of the heads H. The VCM 132 is driven by current (or voltage) supplied from the motor driver IC 20. The head suspension 131 and the VCM 132 are included in an actuator. The actuator controls, by driving the VCM 132, movement of the head H supported by the head suspension 131 to a particular position above the recording surface S of the disk 11. With this configuration of the HSA 13, the head H can move in a radial direction of the recording surface S of the disk 11.

The head amplifier IC 14 supplies, to the head H, write signals (current) based on write data input from the R/W channel 16. Furthermore, the head amplifier IC 14 amplifies read signals output from the head H (the read data read from the disk 11 by the head H) and transmits the amplified signals to the R/W channel 16.

The RAM 15 is used as a temporary storage area and constituted by a volatile memory, such as a dynamic RAM (DRAM) or a static RAM (SRAM). The RAM 15 includes a command queue 151, a buffer 152, and a group classification information storage area 153. The command queue 151 queues a command received from a host device HC. In the state immediately after the disk device 10 is activated, the command queue 151 does not store any commands. In the state in which reordering processing, which will be described later, has not been performed, the command queue 151 stores commands from the host device HC in the order of reception. Furthermore, in accordance with the reordering processing is performed, the commands in the command queue 151 are reordered.

The buffer 152 includes a write buffer and a read buffer. The write buffer temporarily stores data to be written to the disk 11 by a command to write the write data to the disk 11 (hereinafter, referred to as a write command). The read buffer temporarily stores data read from the disk 11 by a command to read the read data from the disk 11 (hereinafter, referred to as a read command).

Here, the write command includes, among logical sectors managed in the disk 11, a start logical block address (hereinafter, referred to as an LBA) and write data length of logical sector which is a writing destination of the write data. Furthermore, the read command includes, among logical sectors managed in the disk 11, a start LBA which stores the read data to be read and the read data length of the logical sector.

The group classification information storage area 153 stores group classification information. In the present embodiment, the disk 11 divides consecutive physical positions (physical addresses) into a plurality of groups so that a range of the consecutive physical positions belongs to one group in the disk 11. In other words, physical positions of a storage area are consecutive in a group, and inconsecutive physical positions are not classified into a group. The group is used as a unit to perform the reordering processing. Note that, when a logical address, such as an LBA, is assigned to correspond to a physical address, the LBA may be used as an index indicating the physical position. The following descriptions are based on the assumption that the LBA is assigned so as to correspond to the physical address.

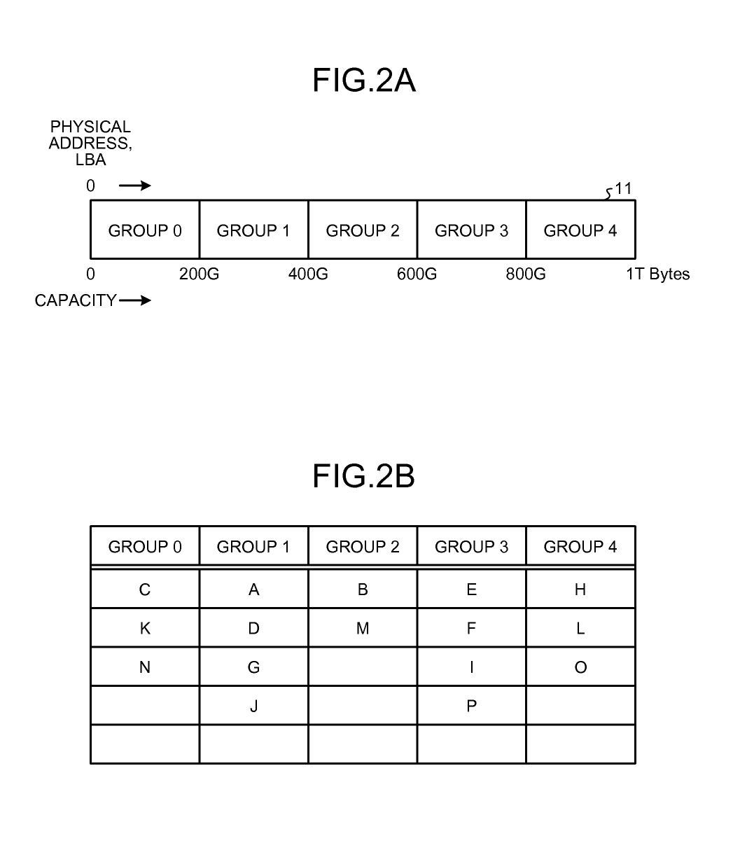

FIGS. 2A and 2B are diagrams to explain the group classification information. FIG. 2A is a diagram illustrating an example of grouping the storage area of the disk, and FIG. 2B is a diagram illustrating an example of the group classification information. FIG. 2A illustrates that the storage area of the disk 11 is divided into five groups. For example, when the storage capacity of the disk 11 is 1T bytes, the storage area is divided from the leading physical address (or LBA) in units of 200G bytes. Consequently, the groups 0, 1, 2, 3, and 4 are generated in ascending order of the physical address area. The group classification information indicates which group the commands stored in the command queue 151 belong to. In the example illustrated in FIG. 2B, the commands included in the respective groups are listed in a table. Here, A to P indicate commands.

The R/W channel 16 is a signal processing circuit. In the present embodiment, the R/W channel 16 encodes the write data input from the HDC 17 (code modulation) and output the encoded data to the head amplifier IC 14. Furthermore, the R/W channel 16 decodes the read data transmitted from the head amplifier IC 14 (code demodulation) and outputs the decoded data to the HDC 17.

The HDC 17 is a communication interface which enables communication with the host device HC. More specifically, when receiving the write command from the host device HC, the HDC 17 stores the write command in the command queue 151 of the RAM 15 and the write data in the buffer 152 of the RAM 15. After the writing processing, the HDC 17 returns a response to the host device HC. When receiving the read command from the host device HC, the HDC 17 stores the read command in the command queue 151 and returns, to the host device HC, the read data stored in the buffer 152 by the reading processing.

Furthermore, the HDC 17 performs classification processing of the command stored in the command queue 151. In the classification processing of the command, when receiving the command, the HDC 17 refers to a start LBA of the access destination included in the command and determines the group including the start LBA of the access destination in the range. Then, the HDC 17 records the determined result in the group classification information stored in the group classification information storage area 153. In other words, the HDC 17 classifies the command to be stored in the command queue 151 into groups based on the start LBA of the access destination. Note that, firmware by the CPU 18 may execute the classification processing of the command stored in the command queue 151.

Moreover, the HDC 17 executes the reordering processing of the queued commands. Generally in the disk device 10, when the head H is moved to a desired track and a desired sector is moved to the position of the moved head H, the access to the disk 11 is performed. Here, the distance and the time to move the head H to the desired track are called a seek distance and a seek time respectively, and the time while waiting for the desired sector to move to the position of the head H above the desired track is called a rotation waiting time. In order to accelerate the processing in the disk device 10, it is required to select a next command so as to minimize the seek time and the rotation waiting time. Note that, firmware by the CPU 18 may execute the reordering processing of the queued commands.

Therefore, when the next command is executed after the command being executed, the reordering processing is executed to select a command to be executed next from a plurality of commands so that the access to the disk 11 is effectively performed. In the reordering processing according to the present embodiment, as described later, the disk 11 is divided into a plurality of groups in which their physical positions are in the vicinity, and the command to be executed next is selected from the same group as the command being executed or the adjacent group.

The CPU 18 is a main controller of the disk device 10 and executes various types of processing, such as control processing to write the write data and to read the read data by the head H, and servo control processing to control the position of the head H above the recording surface S of the disk 11. Note that, the CPU 18 executes the above various types of processing by a program stored in a nonvolatile storage medium, such as a read only memory (ROM) (not illustrated) and the disk 11.

The motor driver IC 20 supplies current or voltage to the spindle motor 12 and drives the spindle motor 12 at a particular rotating speed. Furthermore, the motor driver IC 20 supplies the current or voltage designated by the CPU 18 to the VCM 132 and drives the actuator.

In the present embodiment, the R/W channel 16, the HDC 17, and the CPU 18 are incorporated onto an integrated circuit 19 called a system on chip (SoC) which is a chip integrating all components. The integrated circuit 19 functions as a controller in the broad sense of the term.

Next, a controlling method of the disk device 10 having the above described configuration will be described. In the following descriptions, the group classification processing of the command received from the host device HC and the reordering processing of the commands will be described in order.

<Group Classification Processing of the Command>

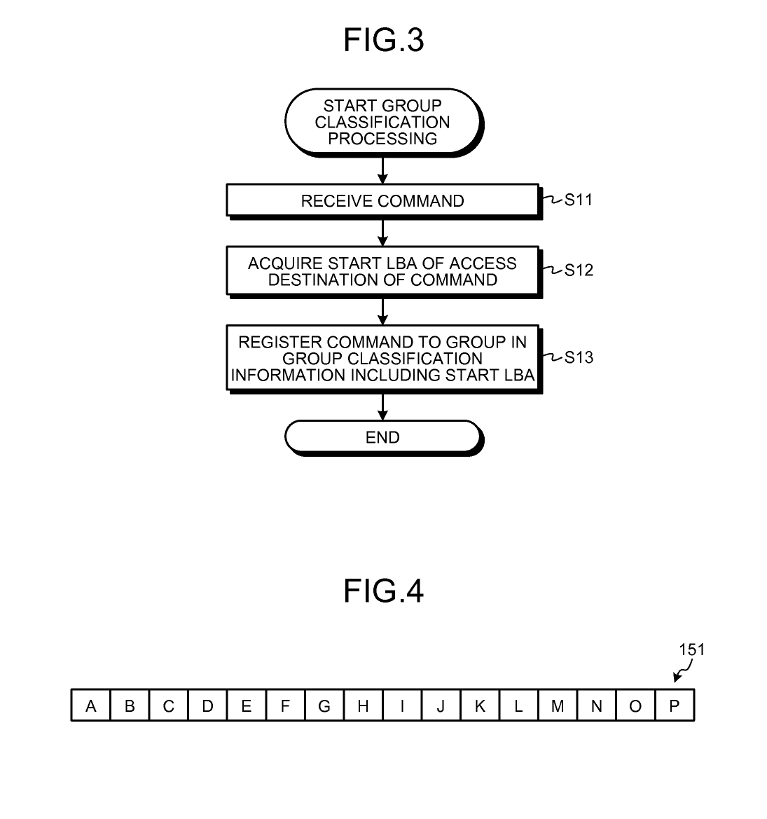

FIG. 3 is a flowchart illustrating an example of a procedure of the group classification processing of the command. First, when receiving the command from the host device HC (S11), the HDC 17 stores the command in the command queue 151. When the command is a write command, the write data is stored in the buffer 152. Furthermore, the HDC 17 acquires the start LBA of the access destination of the received command (S12). Then, the HDC 17 registers the command in the group including the acquired start LBA in the group classification information (S13), and the group classification processing of the command is ended.

FIG. 4 is a diagram schematically illustrating an example of commands stored in the command queue. When receiving the command from the host device HC, the HDC 17 stores the command in the command queue 151 in order of reception. FIG. 4 illustrates that state. Here, it is illustrated that the commands are received in the order of A to P.

Furthermore, the result of performing the group classification processing illustrated in FIG. 3 to the commands stored in the command queue 151 is illustrated in FIG. 2B. For example, FIG. 2B illustrates the commands classified in the group 0 are the commands C, K, and N, the commands classified in the group 1 are the commands A, D, G, and J. Similarly, the other groups indicate the classified commands.

<Reordering Processing of the Commands>

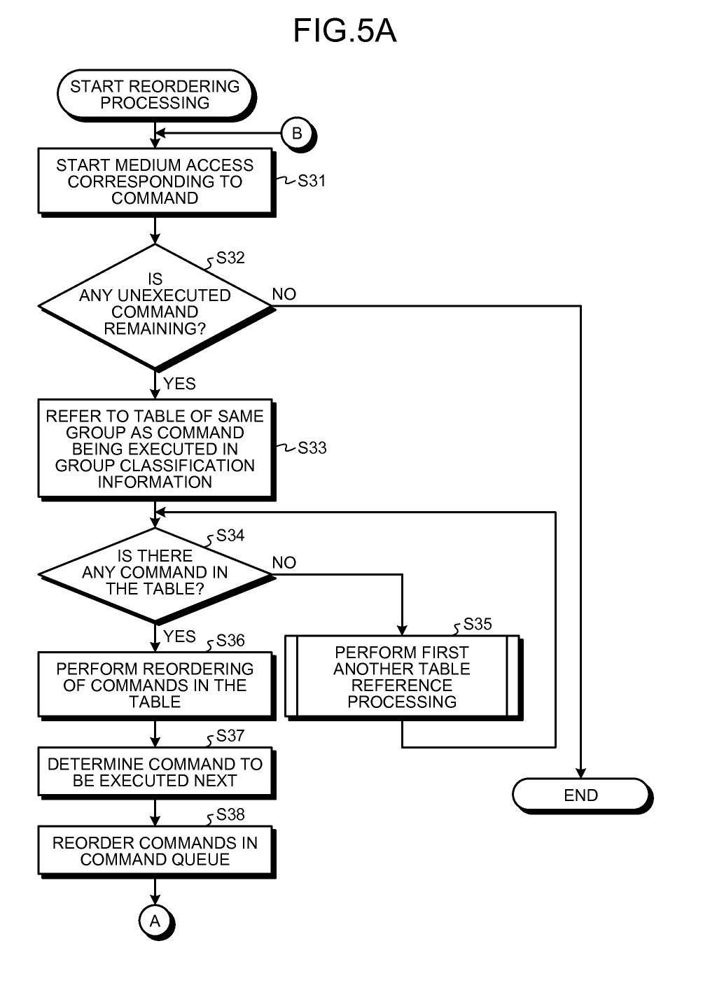

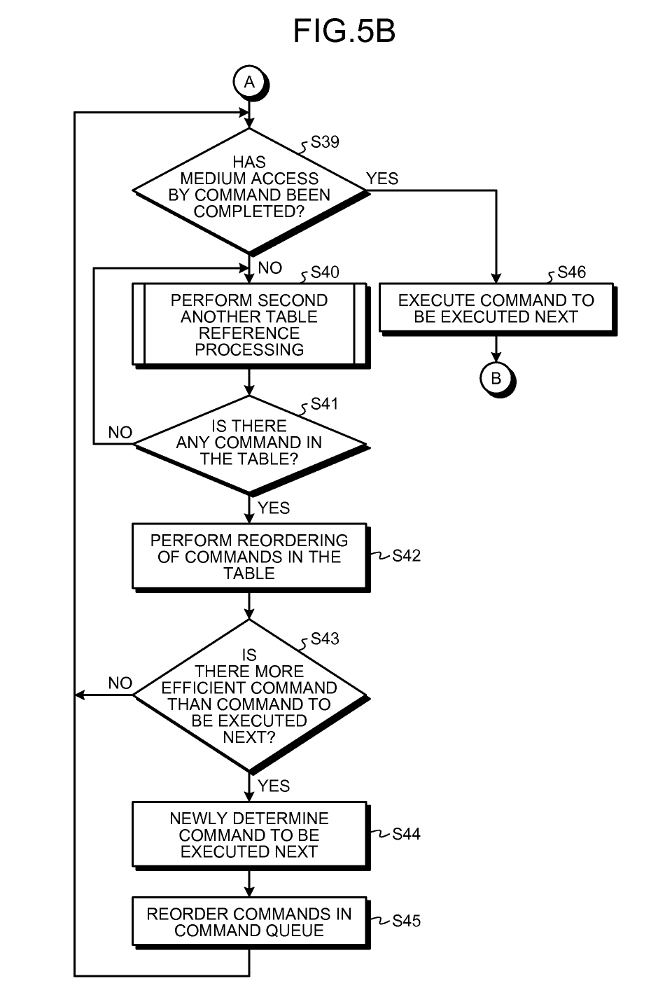

FIGS. 5A and 5B are flowcharts illustrating an example of a procedure of the reordering processing of the commands. First, the HDC 17 extracts and executes the leading (oldest) command of the command queue 151. Thus, medium access based on the command is started (S31).

Next, the HDC 17 determines whether there exists an unexecuted command in the command queue 151 (S32). When there are no unexecuted commands (“No” in S32), the processing is ended since there is no reordering target. On the other hand, when there is an unexecuted command (“Yes” in S32), the HDC 17 refers to the table of the same group as the command being executed in the group classification information (S33).

Next, the HDC 17 determines whether there exists a command in the referred table (S34). When there are no commands in the table (“No” in S34), the HDC 17 performs first another table reference processing in which a table of the group adjacent to the referred group in a particular direction (S35). Thereafter, the processing returns to S34.

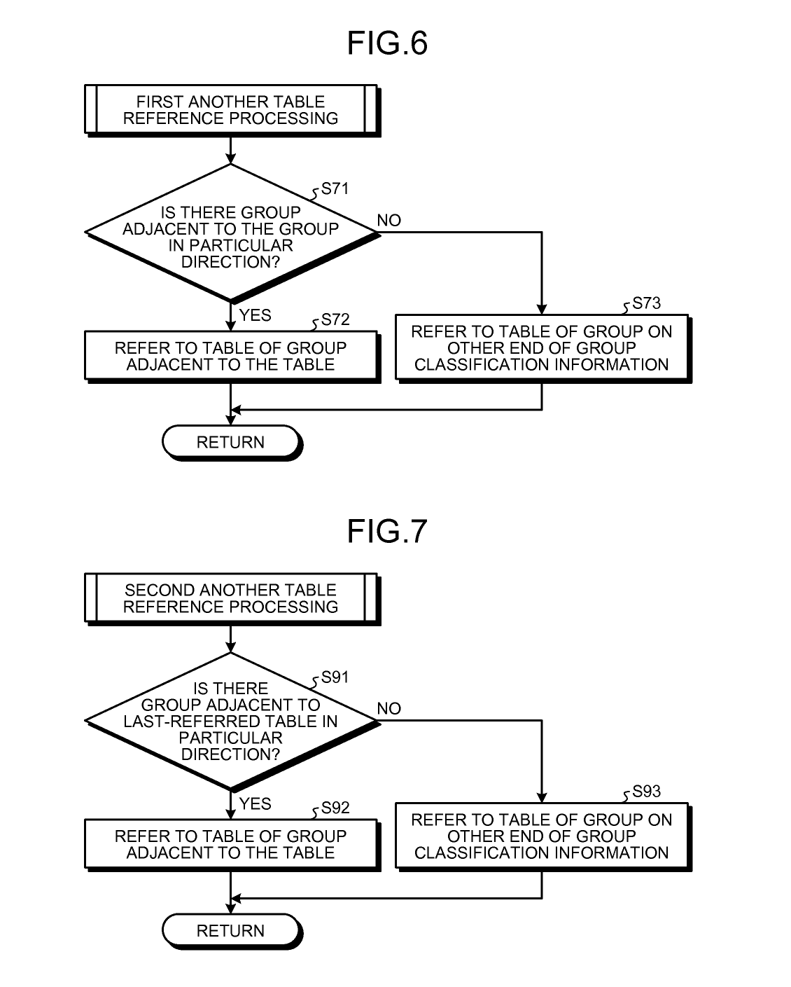

FIG. 6 is a flowchart illustrating an example of a procedure of the first another table reference processing. In the processing, first, the HDC 17 determines whether there exists a group adjacent to the group being referred to in a particular direction (S71). Here, the particular direction is either of the direction of increasing or decreasing the physical address (or LBA), and set in advance. In the example of the processing described in the present embodiment, the particular direction is the direction of increasing the physical address.

When there is a group adjacent to the group being referred to (“Yes” in S71), the HDC 17 refers to the table of the group adjacent to the table (S72). For example, when the table being referred to is any one of the groups 0 to 3 in FIG. 2A, there is an adjacent group in the direction of increasing the physical address. Therefore, the table of the group adjacent to the table being referred to in the direction of increasing the physical address is referred to. Then, the processing returns to FIG. 5A.

On the other hand, when there are no groups adjacent to the group being referred to (No in S71), in other words, when the group being referred to exists on one end in the physical address order of the group, the HDC 17 refers to the table of the group on the other end of the group classification information (S73). For example, when the table being referred to is the group 4 in FIG. 2A, the group 4 has the last physical address of the disk 11. Therefore, in the physical address order of the group, the group 4 constitutes the one end. In other words, there are no adjacent groups in the direction of increasing the physical address. In this case, the table of the group 0, which exists on the other end of the group classification information and has the leading physical address, is referred to. Then, the processing returns to FIG. 5A.

In S34 of FIG. 5A, when there is a command in the table being referred to (“Yes” in S34), the HDC 17 performs reordering of the commands included in the table (S36). More specifically, the HDC 17 calculates the processing time when the respective commands in the table being referred to are executed following the command being executed. Either or both of the seek time or/and the rotation waiting time is/are used as the processing time.

Next, the HDC 17 determines, as the command to be executed next, the command to be executed in the shortest time among the commands in the table being referred to (S37). Then, the HDC 17 performs the reordering of the commands in the command queue 151 so that the command to be executed next is executed next (S38).

Thereafter, the HDC 17 determines whether the medium access by the command being executed has been completed (S39). The medium access time by the command varies based on the data length of the access destination. For example, when the data length of the access destination is long, the medium access by the command takes a long time. On the other hand, when the data length of the access destination is short, the medium access by the command takes a short time.

When the medium access has not been completed (“No” in S39), the HDC 17 performs second another table reference processing (S40).

FIG. 7 is a flowchart illustrating an example of a procedure of the second another table reference processing. First, the HDC 17 determines whether there exists a group adjacent to the last-referred table in the particular direction (S91). Here, when the second another table reference processing is executed for the first time, the last-referred table is the table which is last referred to among the tables which have been referred to in S33 and S35. Furthermore, when the second another table reference processing is executed for the second time, the last-referred table is the table which is referred to in the previous second another table reference processing.

When there is a group adjacent to the last-referred table (“Yes” in S91), the HDC 17 refers to the table of the group adjacent to the last-referred table (S92). On the other hand, when there are no groups adjacent to the last-referred table (“No” in S91), the HDC 17 refers to the table of the group on the other end of the group classification information (S93). After S92 or S93, the processing returns to FIG. 5B.

Thereafter, the HDC 17 determines whether there exists a command in the table being referred to in FIG. 5B (S41). When there are not commands in the table (No in S41), the processing returns to S40. On the other hand, when there is a command in the table being referred to (Yes in S41), the HDC 17 performs the reordering of the commands included in the table (S42). Note that, when the second another table reference processing of S40 is performed for the first time, the above table is the table of the group obtained by performing the second another table reference processing to the table to which the reordering is performed in S36. Furthermore, when the second another table reference processing of S40 is performed for the second time or later, the above table is the table of the group obtained by performing the second another table reference processing to the table of the group which is referred to in the previous second another table reference processing. The HDC 17 calculates the processing time of each command in the table being referred to when the command is executed following the command being executed. Either or both of the seek time or/and the rotation waiting time can be used as the processing time.

Next, the HDC 17 determines whether there exists a more efficient command than the command to be executed next among the reordered commands (S43). Here, the term “efficient” means that the processing time is short. When there is a more efficient command than the command to be executed next (Yes in S43), the HDC 17 determines the efficient command as the command to be executed next (S44). However, when there is a plurality of efficient commands than the command to be executed next, the HDC 17 selects the most efficient command among the commands. Then, the HDC 17 performs the reordering of the commands in the command queue 151 so that the command to be executed next is executed next to the command being executed (S45). Thereafter or in S43, when there are no more efficient commands than the command to be executed next (No in S43), the processing returns to S39.

When the medium access by the command executing in S39 has been completed (Yes in S39), the HDC 17 executes the command to be executed next (S46). The command has been first reordered in the command queue 151 as the execution order of the command. Then, the processing returns to S31. With the above exemplified procedure, the reordering processing is performed.

Next, a specific example of the reordering processing will be described. Here, it will described cases where all of the groups in the command classification information include a command and the group including the command being executed does not include a command.

<A Case Where All of the Groups in the Command Classification Information Include a Command>

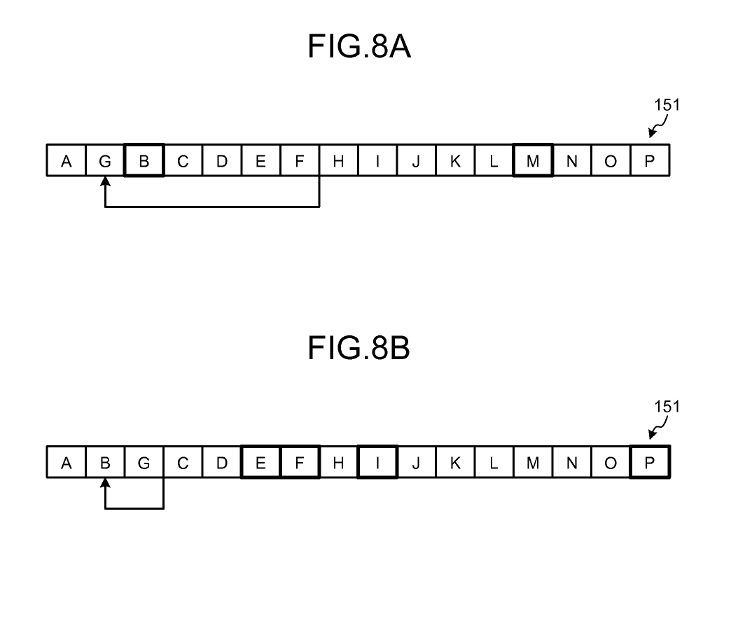

FIGS. 8A and 8B are diagrams schematically illustrating an example of the command state in the command queue. It is assumed that the commands A to P are stored in order in the command queue 151 as illustrated in FIG. 4, and the respective commands are classified into the groups as illustrated in FIG. 2B. The command A is executed first, since the command A is stored in the lead of the command queue 151 in FIG. 4. While the command A is executed, the HDC 17 performs the reordering processing.

The table of the group 1 is referred to, since FIG. 2B shows that the command A belongs to the group 1. Furthermore, the table of the group 1 includes the other commands D, G, and J. Therefore, the HDC 17 calculates the processing time of the commands in the group 1 except for the command A when the command is executed following the command A, and select the most efficient command. Here, for example, it is assumed that the command G is determined as the command to be executed next. Consequently, the command G is moved between the commands A and B in the command queue 151 as illustrated in FIG. 8A.

At the time when the above processing is executed, if the medium access by the command being executed A has been completed, the command G which has been determined as the command to be executed next is executed. On the other hand, at the time when the above processing is executed, if the medium access by the command being executed A has not been completed, the second another table reference processing illustrated in FIG. 7 is executed. Then, the reordering processing including the command in the table of the adjacent group 2 in the direction of increasing the physical address is performed. The commands to which the reordering processing is performed are the commands B and M illustrated with thick frames in FIG. 8A. Then, it is determined whether there exists a more efficient command than the command to be executed next when the command is executed following the command A.

When all of the commands in the group 2 are less efficient than the command G to be executed next, the command G remains to be the command to be executed next as illustrated in FIG. 8A. On the other hand, when the command B in the group 2 is more efficient than the command G to be executed next, the command B is determined as a new command to be executed next. Consequently, the command B is moved between commands A and G in the command queue 151 as illustrated in FIG. 8B.

Note that, thereafter, the reordering processing of the commands is performed in the order of the group 3, the group 4, and the group 0 of FIG. 2B until the medium access by the command being executed A is completed. For example, when the reordering processing is performed in the table of the group 3, the commands E, F, I, and P with the thick frames in FIG. 8B are the reordering targets.

<A Case Where the Group Including the Command Being Executed Does Not Include a Command>

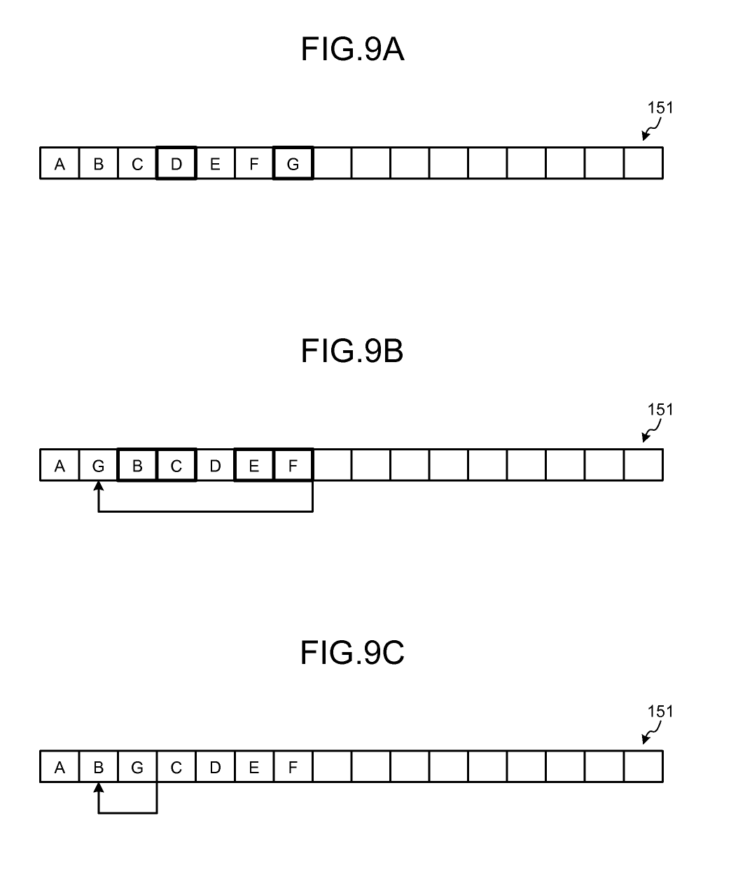

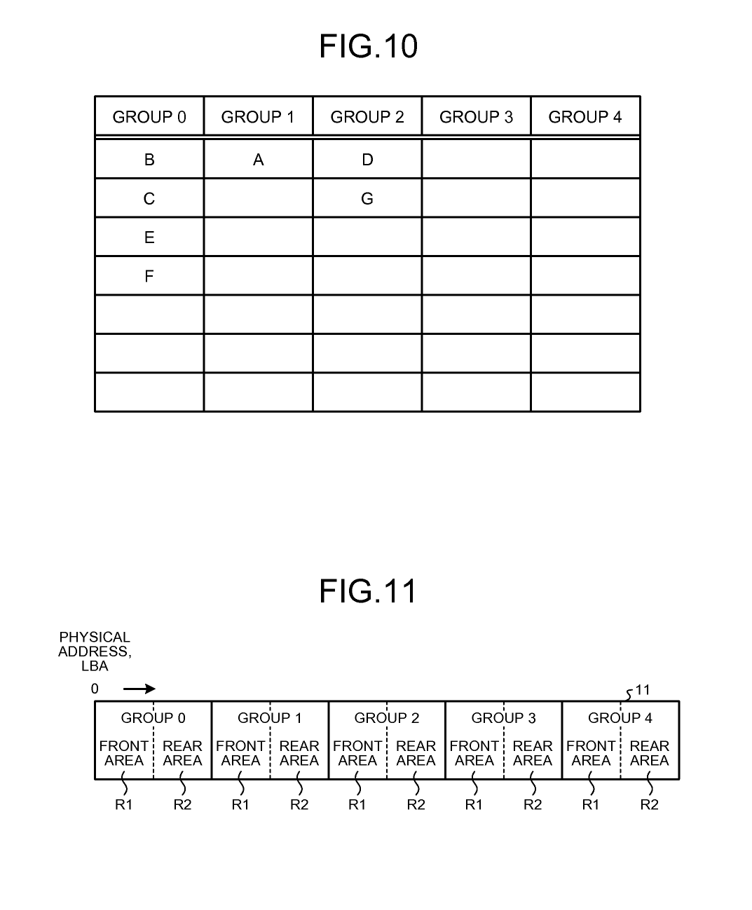

FIGS. 9A to 9C are diagrams illustrating an example of a command state in the command queue, and FIG. 10 is a diagram illustrating an example of the command classification information. In the example, it is assumed that the commands A to G are stored in order in the command queue 151 as illustrated in FIG. 9A, and the respective commands are classified into the groups as illustrated in FIG. 10. The command A is executed first, since the command A is stored in the lead of the command queue 151 in FIG. 9A. While the command A is executed, the HDC 17 performs the reordering processing.

The table of the group 1 is referred to, since FIG. 10 shows that the command A belongs to the group 1. In the example of FIG. 10, the table of the group 1 does not include another command. Therefore, the HDC 17 executes the first another table reference processing illustrated in FIG. 6. Then, the HDC 17 refers to the table of the adjacent group 2 in the direction of increasing the physical address.

The commands D and G are included in the group 2 as illustrated in FIG. 10 (the reordering processing target commands D and G are illustrated with thick frames in FIG. 9A). Therefore, the HDC 17 calculates the processing time of the commands in the group 2 when the command is executed following the command A, and selects the most efficient command. Here, for example, it is assumed that command G is determined as the command to be executed next. Consequently, the command G is moved between the commands A and B in the command queue 151 as illustrated in FIG. 9B.

At the time when the above processing is executed, if the medium access by the command being executed A has been completed, the command G which has been determined as the command to be executed next is executed. On the other hand, at the time when the above processing is executed, if the medium access by the command being executed A has not been completed, the table of the group 3, which is adjacent to the group 2 in the direction of increasing the physical address, is referred to. However, the group 3 does not also include a command. Thereafter, although the group 4 adjacent to the group 3 is referred to, the group 4 does not include a command, either. The group 4 has the last physical address of the storage area of the disk 11, thus the group 0 which has the leading physical address is referred to next to the group 4. In the example of FIG. 10, the group 0 includes the commands B, C, E, and F (the reordering processing target commands B, C, E, and F are illustrated with thick frames in FIG. 9B). Therefore, the HDC 17 performs the reordering processing including the commands in the group 0. Then, the HDC 17 determines whether there exists a more efficient command than the command to be executed next when the command is executed following the command A.

When all of the commands in the group 0 are less efficient than the command G to be executed next, the command G remains to be the command to be executed next as illustrated in FIG. 9B. On the other hand, when the command B in the group 0 is more efficient than the command G to be executed next, the command B is determined as a new command to be executed next. Consequently, the command B is moved between the commands A and G in the command queue 151 as illustrated in FIG. 9C.

Note that, thereafter, the reordering processing of the commands is performed in the order of the group 1, the group 2, and so on in FIG. 10 until the medium access by the command being executed A is completed.

Note that, in the above description, when referring to another table, the HDC 17 selects a group adjacent to the group being referred to in the direction of increasing the physical address (or LBA). However, this is an example, and the HDC 17 may select an adjacent group in the direction of decreasing the physical address (or LBA).

Furthermore, when referring to another table, the HDC 17 may select a group so that, for example, the HDC 17 refers to a first group adjacent in the direction of increasing the physical address, next, refers to a second group adjacent in the direction of decreasing the physical address of the table to which the command being executed belongs, then, refers to a third group adjacent in the direction of increasing the physical address of the first group, and refers to a fourth group adjacent in the direction of decreasing the physical address of the second group.

In the first embodiment, the disk device 10 having the disk 11 and the controller queues the command from the host device HC and reorders the commands which access the vicinity of the physical position of the access destination in the command being executed. Thus, as compared to reordering all of the commands in the command queue 151 as targets, the number of the commands as the reordering targets is limited. Consequently, it is possible to reduce overhead of the controller and degradation of performance.

Furthermore, the command having the physical position of the access destination with the short seek time from the physical position of the access destination of the command being executed is designated as the command to be executed next. Therefore, it is possible to reduce power consumption of the disk device 10.

### Second Embodiment

In the first embodiment, when there are no other commands in the table to which the command being executed belongs, or when the medium access by the command has not been completed, the group adjacent to the table to which the command being executed belongs in the particular direction is referred to. The reference direction is the particular direction. In a second embodiment, the case where the reference direction of the adjacent group is determined based on the physical position of the command being executed will be described.

A disk device 10 according to the second embodiment, a HDC 17 further includes a function to determine a reference direction of a table in reordering processing. FIG. 11 is a diagram schematically illustrating an example of a method for determining a table reference direction according to the second embodiment. As illustrated in the diagram, the respective groups are divided into two areas so as to substantially halve the storage capacity of the group. Thus, in each of the groups, a front area R1 where the physical position is small and a rear area R2 where the physical position is large in the group are formed.

The HDC 17 determines the direction of the table to be referred to based on whether the start LBA of the access destination of the command being executed exists in the front area R1 or the rear area R2. More specifically, when a start LBA of the access destination of the commands being executed exists in the front area R1, the direction of decreasing the physical address is selected as the table reference direction. Alternatively, when a start LBA of the access destination exists in the rear area R2, the direction of increasing the physical address is selected as the table reference direction. By selecting the table reference direction in this manner, it is possible to shorten the seek distance between the command being executed and the command to be executed next.

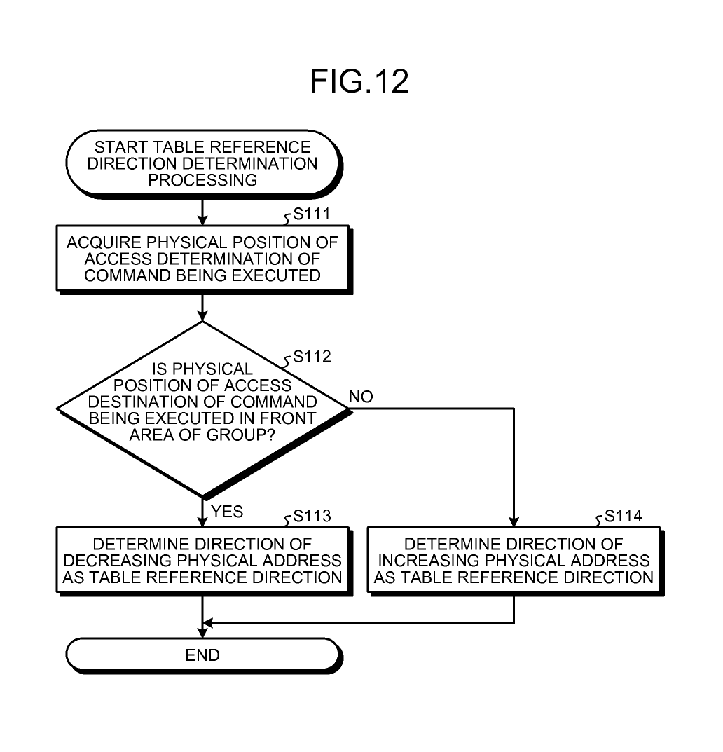

The reordering processing according to the second embodiment is basically the same as that described in the first embodiment. However, is different in that table reference direction determination processing is executed between S34 and S35 of FIG. 5A. FIG. 12 is a flowchart illustrating an example of a procedure of the table reference direction determination processing according to the second embodiment.

First, the HDC 17 acquires the physical position of the access destination of the command being executed (S111). Here, the physical position of a disk 11 corresponds to the LBA, and the physical position can be calculated from the start LBA included in the command.

Next, the HDC 17 determines whether the physical position of the access destination of the command being executed exists in the front area R1 of the group (S112). When the physical position of the access destination of the command being executed exists in the front area R1 (“Yes” in S112), the HDC 17 determines the direction of decreasing the physical address as the table reference direction (S113), and the processing is ended. Alternatively, when the physical position of the access destination of the command being executed does not exist in the front area R1, in other words, exists in the rear area R2 (“No” in S112), the HDC 17 determines the direction of increasing the physical address as the table reference direction (S114), and the processing is ended.

Note that, in the above description, the case where the table reference direction determination processing of FIG. 12 is executed between S34 and S35 of FIG. 5A has been described. In this case, the table reference direction which has been once determined is stored and used thereafter. However, the table reference direction determination processing of FIG. 12 may be executed between S39 and S40 of FIG. 5B.

In the second embodiment, the reordering target group is selected based on the position of the group to which the command being executed belongs. Consequently, it is possible to reduce the seek time required when the command being executed is followed by the command to be executed.

Note that, the flowchart illustrated in the above embodiment is an example. Therefore, the processing may not be performed in the illustrated order.

Furthermore, in the above described example, it has been described that the LBA is assigned so as to correspond to the physical address of the disk 11. However, the above described embodiment is applicable to the case where the LBA is assigned so as not to correspond to the physical address of the disk 11. In this case, by using address conversion information indicating the correspondence relation between the LBA and the physical address, the LBA is converted into the physical address, and the processing is executed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A disk device comprising:
a disk configured to store data; and
a controller configured to control writing data to the disk and reading data from the disk,
wherein the controller is configured to queue a command from a host device, execute a first command included in the queued command, and execute reordering processing to a plurality of commands which accesses a vicinity of a physical position of an access destination of the first command.

2. The disk device according to claim 1, wherein the controller is configured to classify, when receiving the command from the host device, the command into a group corresponding to a physical position of an access destination of the command, the group being a plurality of areas into which the disk is divided such that physical positions are consecutive in the group.

3. The disk device according to claim 2, wherein the controller is configured to execute, in the case where another command exists in a first group to which a physical position of the access destination of the first command belongs, the reordering processing to the another command.

4. The disk device according to claim 3, wherein the controller is configured to execute, in the case where the another command does not exist in the first group, the reordering processing to a command in a second group obtained in a particular order from the first group, the particular order being an order of increasing or decreasing of position information indicating a physical position with respect to a physical position of the first group.

5. The disk device according to claim 3, wherein the controller is configured to repeatedly execute, in the case where access processing to the disk of the first command has not been completed at the end of the reordering processing, the reordering processing to a command in a second group obtained in a particular order from the first group until the access processing is completed, the particular order being an order of increasing or decreasing of position information indicating a physical position with respect to a physical position of the first group.

6. The disk device according to claim 5, wherein the controller is configured to refer, in the case where the command does not exist in the second group, to a next group based on the particular order without executing the reordering processing.

7. The disk device according to claim 4, wherein the controller is configured to repeatedly execute, in the case where access processing to the disk of the first command has not been completed at an end of the reordering processing, the reordering processing including a command in a third group obtained in the particular order from the second group until the access processing is completed.

8. The disk device according to claim 7, wherein the controller is configured to refer, in the case where the command does not exist in the third group, to a next group based on the particular order without executing the reordering processing.

9. The disk device according to claim 4, wherein
the controller is configured to:
determine, in the case where a physical position of an access destination of the first command is in a front area where a physical position is smaller than a middle of the first group, the particular order being as an order of decreasing the position information, and
determines, in the case where the physical position of the access destination of the first command is in a rear area where a physical position is larger than the middle of the first group, the particular order being as an order of increasing the position information.

10. The disk device according to claim 1, wherein
a logical address to be assigned to the disk is assigned so as to correspond to a physical address, and
the controller is configured to perform processing using the logical address as the physical position.

11. A controlling method of a disk device, the method comprising:
queuing a command from a host device;
executing a first command included in the queued command; and
executing reordering processing to a plurality of commands which accesses a vicinity of a physical position of an access destination of the first command.

12. The controlling method according to claim 11, wherein
the disk device includes a disk to store data, and
the method further comprises
classifying, when receiving the command from the host device, the command into a group corresponding to a physical position of an access destination of the command, the group being a plurality of areas into which the disk is divided such that physical positions are consecutive in the group.

13. The controlling method according to claim 12, wherein the executing of the reordering processing of the command, in the case where another command exists in a first group to which a physical position of the access destination of the first command belongs, comprises reordering of the another command.

14. The controlling method according to claim 13, wherein the executing of the reordering processing of the command, in the case where the another command does not exist in the first group, comprises reordering of a command in a second group obtained in a particular order from the first group, the particular order being an order of increasing or decreasing of position information indicating a physical position with respect to a physical position of the first group.

15. The controlling method according to claim 13, wherein the executing of the reordering processing of the command, in the case where access processing to the disk of the first command has not been completed at an end of the reordering processing, comprises repeatedly executing processing to reorder a command in a second group obtained in a particular order from the first group until the access processing is completed, the particular order being an order of increasing or decreasing position information indicating a physical position with respect to a physical position of the first group.

16. The controlling method according to claim 15, wherein the executing of the reordering processing of the command, in the case where the command does not exist in the second group, comprises referring to a next group based on the particular order without executing the reordering.

17. The controlling method according to claim 14, wherein the executing of the reordering processing of the command, in the case where access processing to the disk of the first command has not been completed at an end of the reordering processing, comprises repeatedly executing processing of reordering including a command in a third group obtained in the particular order from the second group until the access processing is completed.

18. The controlling method according to claim 17, wherein the executing of the reordering processing of the command, in the case where the command does not exist in the third group, comprises referring to a next group based on the particular order without executing the reordering.

19. The controlling method according to claim 14, wherein
the executing of the reordering processing of the command comprises,
determining the particular order being as an order of decreasing the position information in the case where a physical position of an access destination of the first command is in a front area where a physical position is smaller than a middle of the first group, and
determining the particular order being as an order of increasing the position information in the case where the physical position of the access destination of the first command is in a rear area where a physical position is larger than the middle of the first group.

20. The controlling method according to claim 11, wherein a logical address to be assigned to the disk is assigned so as to correspond to a physical address.
